(19) United States
(12) Patent Application Publication
(10) Pub. No.: US 2024/0346955 A1
(43) Pub. Date: Oct. 17, 2024

(54) PROTECTIVE CASE ASSEMBLY

(71) Applicant: M1NT, INC., Wilmington, DE (US)

(72) Inventors: Collin M. Newman, Los Angeles, CA (US); Brian P. Bybee, Los Angeles, CA (US); Shannon J. Soong, Fayetteville, GA (US); Samuel J. Norcutt, Lantzville (CA); Jonathan E. Thai, San Jose, CA (US); Michael S. Yim, San Jose, CA (US)

(21) Appl. No.: 18/633,078

(22) Filed: Apr. 11, 2024

Related U.S. Application Data
(60) Provisional application No. 63/495,311, filed on Apr. 11, 2023.

(51) Int. Cl. G09F 1/12

(52) U.S. Cl. CPC G09F 1/12

(57) ABSTRACT

A protective case assembly configured to encase, protect, and present for viewing an object having a generally planar structure is provided. The protective case assembly includes a front case assembly having a transparent panel and a rear case assembly configured for attachment to the front case assembly. The rear case assembly has a transparent panel. The rear case assembly is configured to receive an object. In an attached orientation with the front case assembly, the object is viewable through the transparent panel of the rear case assembly and through the transparent panel of the front case assembly. A bezel forms a cavity therewithin. The cavity is configured to receive the front and rear case assemblies in an attached orientation in a manner such that the object is visible through a plurality of apertures formed in the bezel.

### RELATED APPLICATIONS

This application claims the benefit of U.S. Provisional Application No. 63/495,311 filed on Apr. 11, 2023. The entire disclosure of this application is incorporated herein by reference in its entirety.

### FIELD

The present disclosure relates generally to a protective case assembly and, more particularly, to a protective case assembly for a piece and/or object having a generally planar structure and needing protection from handling and the elements, wherein the protective case assembly is configured to prevent damage to the piece and enhances visual presentation of the piece.

### INTRODUCTION

This section provides background information related to the present disclosure which is not necessarily prior art.

In certain instances, it is desirable to protect objects having a generally planar structure from damage due to handling, mishandling and environmental elements. The objects can have a smaller presentation, such as the non-limiting examples of sports and special interest trading cards, concert ticket stubs, sporting event ticket stubs, nametags, postal cards, mailing envelopes and the like. The objects can have a larger presentation, such as the non-limiting examples of diplomas, licenses, certificates, posters, artwork, tapestries, record album covers and the like.

Current options for protecting these types of objects can be bulky, expensive, difficult to assemble, difficult to disassemble and may not provide the desired enhanced visual presentation of the object.

Therefore, it would be advantageous if protective case assemblies could be improved to better protect and present for viewing objects having a generally planar structure.

### SUMMARY

It should be appreciated that this Summary is provided to introduce a selection of concepts in a simplified form, the concepts being further described below in the Detailed Description. This Summary is not intended to identify key features or essential features of this disclosure, nor is it intended to limit the scope of the protective case assembly.

The above objects as well as other objects not specifically enumerated are achieved by a protective case assembly configured to encase, protect, and present for viewing an object having a generally planar structure. The protective case assembly includes a front case assembly having a transparent panel and a rear case assembly configured for attachment to the front case assembly. The rear case assembly has a transparent panel. The rear case assembly is configured to receive an object. In an attached orientation with the front case assembly, the object is viewable through the transparent panel of the rear case assembly and through the transparent panel of the front case assembly. A bezel forms a cavity therewithin. The cavity is configured to receive the front and rear case assemblies in an attached orientation in a manner such that the object is visible through a plurality of apertures formed in the bezel.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective front view of a novel, protective case assembly in accordance with the invention.

FIG. 2 is a rear perspective view of the novel, protective case assembly of FIG. 1.

FIG. 3 is an exploded perspective view of the novel, protective case assembly of FIG. 1.

FIG. 4 is an exploded perspective view of an insertion assembly of the novel, protective case assembly of FIG. 1.

FIG. 5A is an exploded perspective view of the novel, protective case assembly of FIG. 1 illustrating the insertion of the assembly of FIG. 4 into the bezel of FIG. 1.

FIG. 5B is a perspective view of a portion of the novel, protective case assembly of FIG. 1 illustrating partial insertion of the assembly of FIG. 4 into the bezel of FIG. 1.

FIG. 6 is an expanded view of a portion of the novel, protective case assembly of FIG. 1 illustrating an optional surface treatment of a thickened edge.

FIG. 7 is a perspective view of a plurality of novel, protective case assemblies of FIG. 1, shown in a stacked arrangement.

### DETAILED DESCRIPTION

The following description of technology is merely exemplary in nature of the subject matter, manufacture, and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping, or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one clement or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

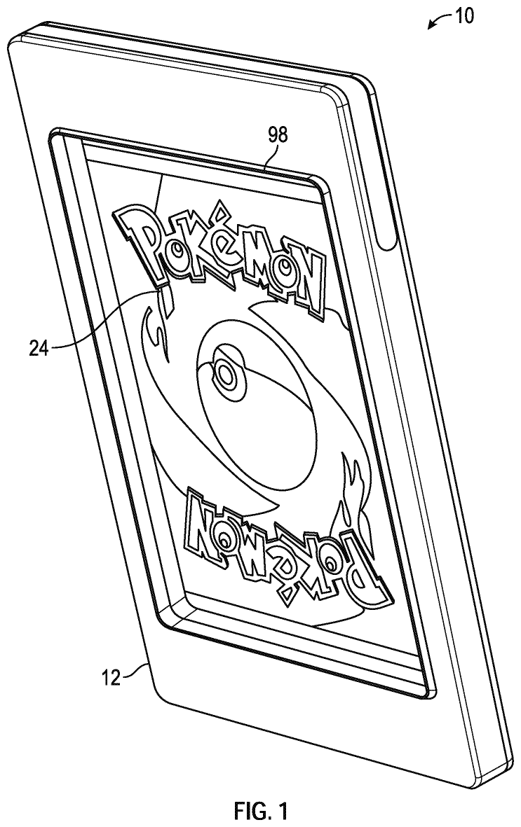

Referring now to FIGS. 1-3 and in accordance with the illustrated embodiments of the present disclosure, a novel protective case assembly (hereafter “case assembly”) is illustrated generally at 10. The case assembly 10 is configured to encase, protect, and present for viewing an object having a generally planar structure in a protective enclosure that facilitates viewing of both front and rear major sides of the object while protecting the object from handling, mishandling damage, and damage from environmental elements. The case assembly 10 includes a bezel element 12, a front case assembly 14 and a rear case assembly 16.

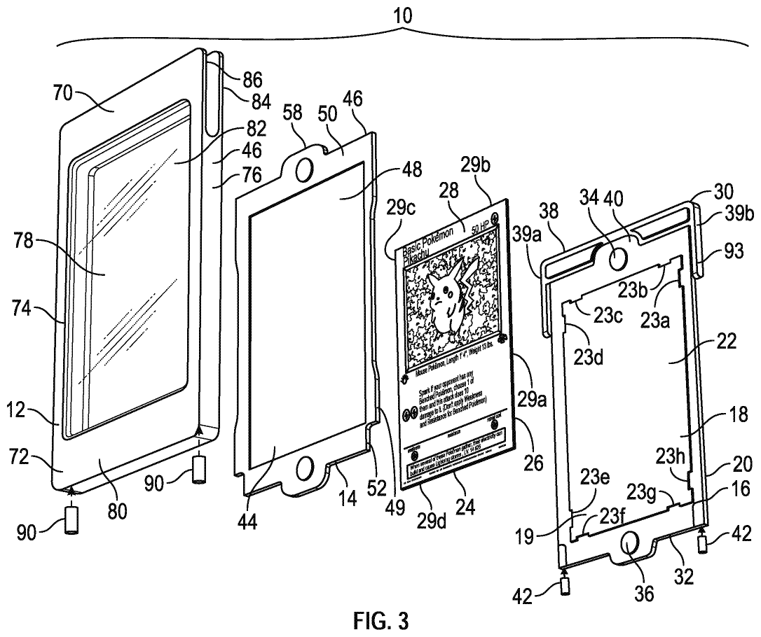

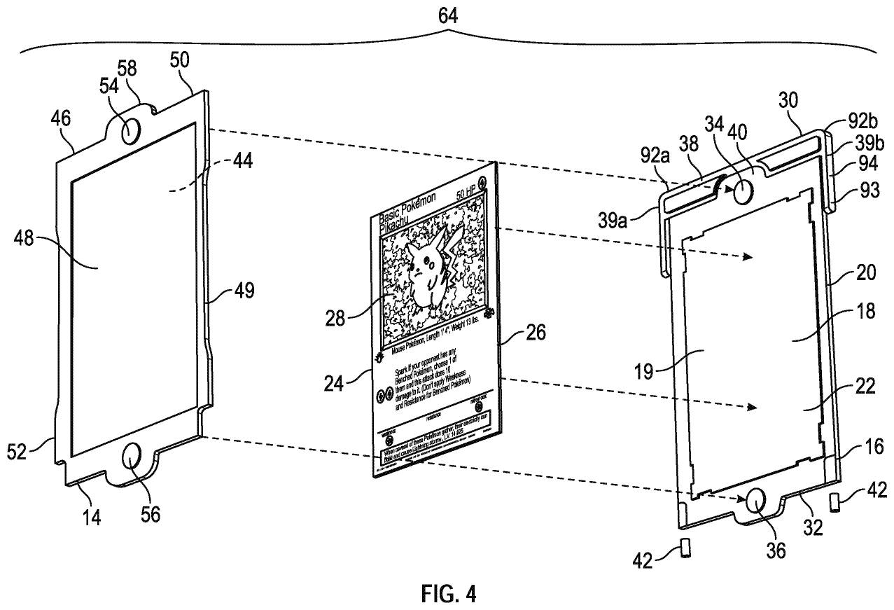

Referring now to FIGS. 3 and 4, the rear case assembly 16 includes a recessed pocket 18 defined by a perimeter framing 20. The recessed pocket 18 includes a transparent panel 22 having an interior surface 19. The transparent panel 22 extends to a perimeter of the recessed pocket 18. The perimeter framing 20 includes a plurality of inward extending positioning tabs 23a-23h. As will be explained in more detail below, the positioning tabs 23a-23h are configured to contact edges of the object 24, thereby positioning the object 24 in the recessed pocket 18 and substantially centering the object 24 on the transparent panel 22.

Referring again to FIGS. 3 and 4, the recessed pocket 18 is configured to receive an object 24 in a manner such that a first major surface 26 of the object 24 seats against the interior surface 19 of the transparent panel 22. The object 24 is seated as a first major edge 29a of the object 24 contacts the positioning tabs 23a, 23h, a first minor edge 29b contacts the positioning tabs 23b, 23c, a second major edge 29c contacts the positioning tabs 23d, 23e and a second minor edge 29d contacts the positioning tabs 23f, 23g. The recessed pocket 18 has a size and shape that approximates the size and shape of the object 24. In the illustrated embodiment, the recessed pocket 18 has a rectangular cross-sectional shape that approximates the rectangular cross-sectional shape of the object 24. However, in other embodiments, the recessed pocket 18 and the object 24 can have other cross-sectional shapes sufficient that the object 24 can be received within, and seat against the interior surface 19 of the transparent panel 22 of the recessed pocket 18. It should be appreciated that in other embodiments, other structures (not shown) can be positioned between the first major surface 26 of the object 24 and the interior surface 19 of the transparent panel 22. One non-limiting example of the structure is a conventional picture mat, as is well known in the framing arts.

Referring again to the embodiment illustrated in FIGS. 3 and 4, the object 24 has the form of a trading card, such as a Pikachu trading card from the Pokémon media franchise.

However, it is contemplated that in other embodiments, the size and shape of the recessed pocket 18 can be adjusted to accommodate objects having a larger and or smaller sizes and shapes. It is further contemplated that non-limiting examples of other objects can include diplomas, licenses, certificates, posters, artwork, tapestries, sports and special interest trading cards, needlework, sporting event and concert ticket stubs, record album covers and the like.

Referring again to FIGS. 3 and 4, the rear case assembly 16 further includes a first end 30 and a second end 32. An upper fastener 34 is positioned within the perimeter framing 20 and proximate the first end 30. A lower fastener 36 is positioned within the perimeter framing 20 and proximate the second end 32. The fasteners 34, 36 will be discussed in more detail below.

Referring again to FIGS. 3 and 4, the first end 30 includes a thickened edge 38. The thickened edge 38 extends from a first side edge 39a to a second side edge 39b. The thickened edge 38 forms an indentation 40 proximate the recessed pocket 18. The indentation 40 will be discussed in more detail below.

Referring now to FIG. 4, a plurality of spaced apart end fasteners 42 are attached to the perimeter framing 20 of the rear case assembly 16 at the second end 32. In the illustrated embodiment, each of the plurality of end fasteners 42 is positioned within an enclosure forming a portion of the perimeter framing 20. However, in other embodiments, each of the plurality of end fasteners 42 can be attached to the perimeter framing with other structures, mechanisms, and devices. The plurality of end fasteners 42 will be discussed in more detail below.

Referring again to FIG. 4, the front case assembly 14 includes a recessed pocket 44 defined and surrounded by a perimeter framing 46. The recessed pocket 44 includes a transparent panel 48 that approximates the size and shape of the object 24. In a manner similar to the recessed pocket 18 in the rear case assembly 16, a second major surface 28 of the object 24 seats against an interior surface 49 of the transparent panel 22.

Referring again to FIG. 4, the front case assembly 14 further includes a first end 50 and a second end 52. An upper fastener 54 is located proximate the first end 50 and a lower fastener 56 is located proximate the second end 52. The upper and lower fasteners 54, 56 will be discussed in more detail below.

Referring again to FIG. 4, the first end 50 of the perimeter framing 46 includes a projecting tab 58. The projecting tab 58 has a size, shape and thickness that approximates the size, shape, and depth of the indentation 40 formed in the first end 30 of the rear case assembly 16. The projecting tab 58 will be discussed in more detail below.

Initial steps of the method of assembling the case assembly 10 will now be described. Referring now to FIG. 4 in a first assembly step, with the front case assembly 14 and the rear case assembly 16 separated from each other, the first major surface 26 of the object 24 is seated against the interior surface 19 of the transparent panel 22. Once seated against the interior surface 19 of the transparent panel 22, the object 24 is positioned within the recessed pocket 18 of the rear case assembly 16. In a next step, the front case assembly 14 is seated against the rear case assembly 16 in a manner such that the tab 58 of the front case assembly 14 aligns with and is received within the indentation 40 of the rear case assembly 16. Further to this assembly step, the upper fastener 54 of the front case assembly 14 aligns with the upper fastener 34 of the rear case assembly 16 and the lower fastener 56 of the front case assembly 14 aligns with the lower fastener 36 of the rear case assembly 16. In this assembly position, the perimeter framing 46 of the front case assembly 14 seats against and aligns with the perimeter framing 20 of the rear case assembly 16. In this orientation, the fasteners 34, 36, 54, 56 cooperate to removably connect the front case assembly 14 to the rear case assembly 16. In the illustrated embodiment, the fasteners 34, 36, 54, 56 have the form of rare earth magnets. In alternate embodiments, the fasteners 34, 36, 54, 56 can have other forms sufficient to removably connect the front case assembly 14 to the rear case assembly 16, such as the non-limiting examples of clips, clamps, snaps, brackets and the like.

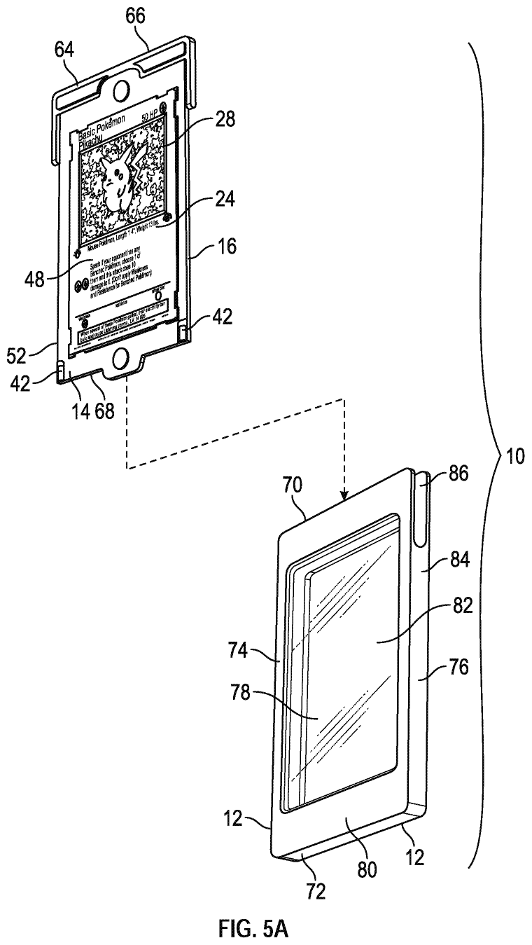

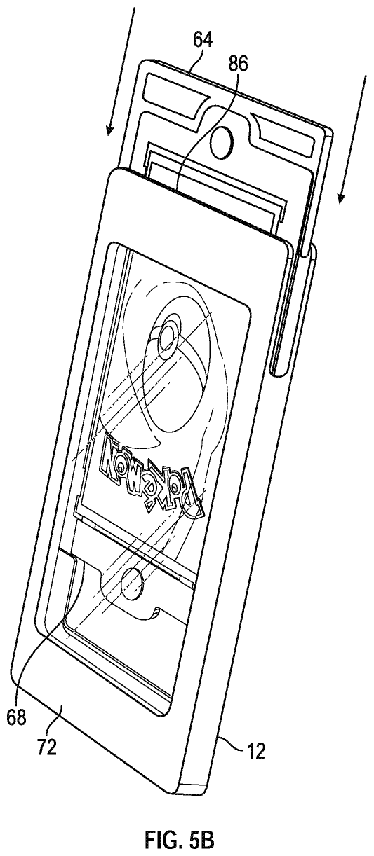

Referring now to FIGS. 4, 5A and 5B, the combination of the front case assembly 14, the object 24 and the rear case assembly 16 forms an insertion assembly 64. It should be appreciated that the insertion assembly 64 facilitates visibility of both major surfaces 26, 28 of the object 24 through the transparent panels 22, 48. The insertion assembly 64 includes the end fasteners 42 previously connected to the rear case assembly 16.

Referring now to FIG. 5A, the insertion assembly 64 forms an upper edge 66 and a lower edge 68. The upper edge 66 is a combination of the thickened edge 38 of the rear case assembly 16 and the first end 50 of the front case assembly 14. The lower edge 68 is a combination of the second end 32 of the rear case assembly 16 and the second end 52 of the front case assembly 14.

Referring now to FIGS. 3 and 5A, the bezel 12 includes an upper member 70, an opposing lower member 72 and opposing side members 74, 76. The members 70, 72, 74 and 76 cooperate to form a first aperture 78 in a front side 80 and a second aperture 82 in a rear side 84. The members 70, 72, 74 and 76 further cooperate to form an interior cavity 86 extending from and through the upper member 70 to the lower member 72. In the illustrated embodiment, the interior cavity 86 has a rectangular cross-sectional size and shape that approximates a rectangular cross-sectional size and shape of the insertion assembly 64. It should be appreciated that in other embodiments, the interior cavity 86 can have other cross-sectional sizes and shapes that approximate the cross-sectional size and shape of the insertion assembly 64.

Referring again to FIG. 3, the bezel 12 further includes a plurality of interior fasteners 90 positioned within the bezel 12, proximate to and secured to the bottom member 72. In the illustrated embodiment, each of the plurality of interior fasteners 90 are the same as, or similar to the end fasteners 42 located in the insertion assembly 64. In other embodiments, the interior fasteners 90 can be different from the end fasteners 42.

Referring now to FIGS. 5A and 5B in a next assembly step, the lower edge 68 of the insertion assembly 64 is inserted into the interior cavity 86 of the bezel 12 in a manner such that the lower edge 68 of the insertion assembly 64 seats against the bottom member 72 of the bezel 12. In this orientation the end fasteners 42, positioned at the lower edge 68 of the insertion assembly 42 and the interior fasteners 90, positioned in the bottom member 72 of the bezel 12 cooperate to removably connect the insertion assembly 64 to the bezel 12. In the illustrated embodiment, the end fasteners 42 and the interior fasteners 90 have the form of rare earth magnets. In alternate embodiments, the end fasteners 42 and the interior fasteners 90 can have other forms sufficient to removably connect the insertion assembly 64 to the bezel 12. It should be appreciated that the upper edge 66 of the insertion assembly 64, formed from the thickened edge 38 of the rear case assembly 16 and the first end 50 of the front case assembly 14, does not allow insertion of the upper edge 66 into the interior cavity 86 of the bezel 12, thereby facilitating the correct assembly of the insertion assembly 64 and the bezel 12.

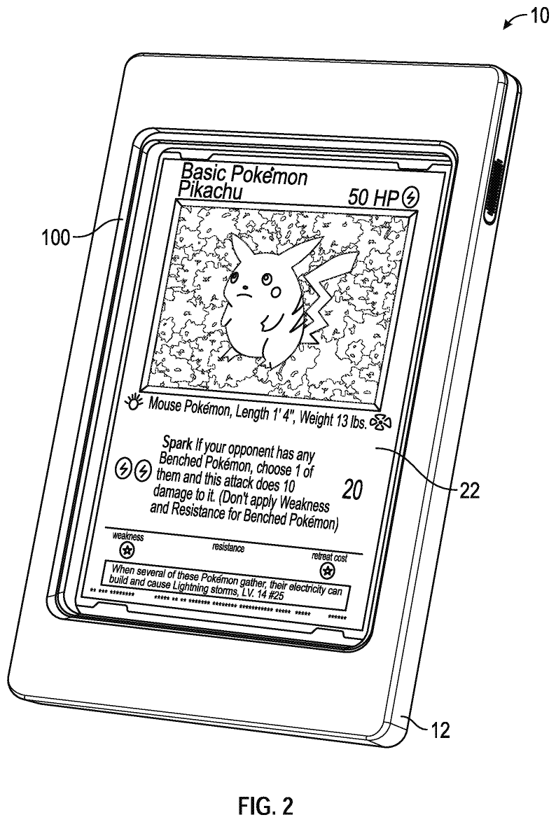

Referring now to FIGS. 1 and 2, an assembled case assembly 10 is illustrated. In the assembled orientation, the second major face 28 of the object 24 is visible through the first aperture 78 of the bezel 12 and through the transparent panel 48 positioned in the front case assembly 14. Further to the assembled orientation, the first major face 26 of the object 24 is visible through the second aperture 82 of the bezel 12 and through the transparent panel 22 positioned in the rear case assembly 16.

It should be appreciated that the use of the fasteners 42, 90 advantageously facilitates retention of the insertion assembly 64 within the bezel 12. It should also be appreciated that the use of the fasteners 42, 90 advantageously facilitates repeated insertion of the insertion assembly 64 into the bezel 12 and repeated removal of the insertion assembly 64 from the bezel 12. It should also be appreciated that the use of the fasteners 34, 36 of the rear case assembly 16 and 54, 56 of the front case assembly 14 advantageously facilitates repeated examination, removal, and/or replacement of the object 24.

Referring now to the embodiment shown in FIGS. 3 and 4, the perimeter framing 46 of front case assembly 14 and the perimeter framing 20 of the rear case assembly 16 are formed polymetric materials, such as the non-limiting examples of polyethylene (PE), acrylic, polypropylene (PP), polycarbonate, cellulose acetate, polyvinyl chloride (PVC) and the like. However, in other embodiments, the perimeter framing 46 of front case assembly 14 and the perimeter framing 20 of the rear case assembly 16 can be formed other materials, suitable for the functions described herein.

Referring again to FIGS. 3 and 4, in certain embodiments the perimeter framing 46 of the front case assembly 14 and the perimeter framing 20 of the rear case assembly 16 can incorporate protective finishes and/or decorative coatings. Protective finishes can be configured to further protect the object 24 from environmental conditions. One non-limiting example of a protective coating is a UV cured coating, configured to help minimize the amount of dangerous ultraviolet radiation received by the object 24. Other non-limiting examples include scratch resistance coatings, anti-fogging coatings, glare reduction coatings, anti-fingerprint coatings and the like. Decorative coatings are configured to provide a desired aesthetic appearance to the perimeter framing 46 of the front case assembly 14, the perimeter framing 20 of the rear case assembly 16 and the transparent panels 22, 48 including the non-limiting examples of frosted finishes, diffused light, reduced glare, a translucent appearance and the like. It should be appreciated that the physically protective and/or decorative coatings can be applied to the to the perimeter framing 46 of the front case assembly 14, the perimeter framing 20 of the rear case assembly 16 and the transparent panels 22, 48 in any suitable manner.

Referring again to the embodiment shown in FIGS. 3 and 4, the transparent panel 48 of front case assembly 14 and the transparent panel 22 of the rear case assembly 16 are formed from a polymeric-based material, such as, but not limited to Optium Museum Acrylic®, manufactured and marketed by Tru Vue, Inc., headquartered in McCook, Illinois. Without being held to the theory, it is believed the use of a polymeric-based material, such as for example, Optium Museum Acrylic® provides many benefits, including the non-limiting examples of UV protection, abrasion resistance, anti-reflective qualities, anti-static qualities, and shatter resistance. It should be appreciated that in other embodiments, the transparent panel 48 of front case assembly 14 and the transparent panel 22 of the rear case assembly 16 can be formed from other suitable materials can be used sufficient to provide the functions described herein.

Referring again to the embodiment shown in FIGS. 3 and 4, the bezel 12 is configured to form a protective enclosure for the insertion assembly 64 and is formed from a lightweight metallic material, such as the non-limiting example of an aluminum-based material. Without being held to the theory, it is believed the use of a lightweight metallic material provides exceptional corrosion resistance, high strength in addition to structural properties. However, it should be appreciated that in other embodiments, other metallic materials can be used, such as the non-limiting examples of magnesium, titanium, beryllium alloys and the like. It should be appreciated that in other embodiments, suitable non-metallic materials can be used to form the bezel 12, including the non-limiting example of reinforced polymeric material, sufficient to provide exceptional corrosion resistance and high strength.

Referring again to FIGS. 3 and 4, in certain embodiments, the material forming the bezel 12 can be coated with physically protective and/or decorative coatings. Protective finishes can be configured to further protect the bezel 12 from environmental conditions. One non-limiting example of a protective coating is a UV cured coating, configured to help minimize the amount of dangerous ultraviolet radiation received by the bezel 12. Other non-limiting examples include scratch resistance coatings, anti-fogging coatings, glare reduction coatings, anti-fingerprint coatings and the like. Decorative coatings are configured to provide a desired aesthetic appearance to the bezel 12 including the non-limiting examples of frosted finishes, diffused light, reduced glare, a translucent appearance and the like. It should be appreciated that the physically protective and/or decorative coatings can be applied to the bezel 12 in any suitable manner.

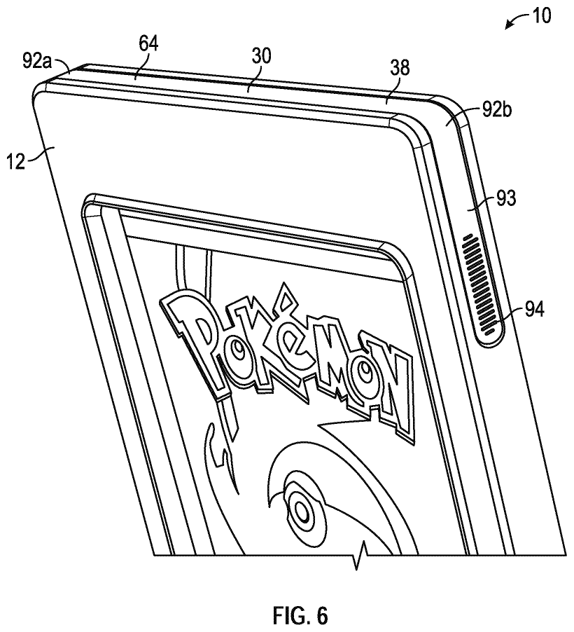

Referring now to FIGS. 4 and 6, the thickened edge 38 extends across the first end 30 of the rear case assembly 16. In certain embodiments, each of opposing first end corners 92a, 92b of the thickened edge 38 have a rounded form. However, in other embodiments, the opposing first end corners 92a, 92b of the thickened edge 38 can have other forms. It should be appreciated that the form of the opposing corners 92a, 92b is not important for successful operation of the case assembly 10.

Referring now to FIGS. 4 and 6, the perimeter framing 20 of the rear case assembly 16 has opposing grip portions 93 located proximate to the first end 30. The grip portions 93 are configured for the access of a user's hand in order to seat the insertion assembly 64 in the bezel 12 and in order to remove the insertion assembly 64 from the bezel 12. In certain embodiments, the opposing grip portions 93 in these embodiments, can be equipped with surface treatments 94 configured to facilitate gripping of the insertion assembly 64. In the illustrated embodiment, the surface treatments 94 have the form of raised parallel lines. However, in other embodiments, the surface treatments 94 can have other forms, including the non-limiting examples of raised nubs, depressions and the like, sufficient to facilitate gripping of the insertion assembly 64 for insertion and/or removal purposes. However, it should be appreciated that the surface treatments 94 are optional and not required for successful operation of the case assembly 10.

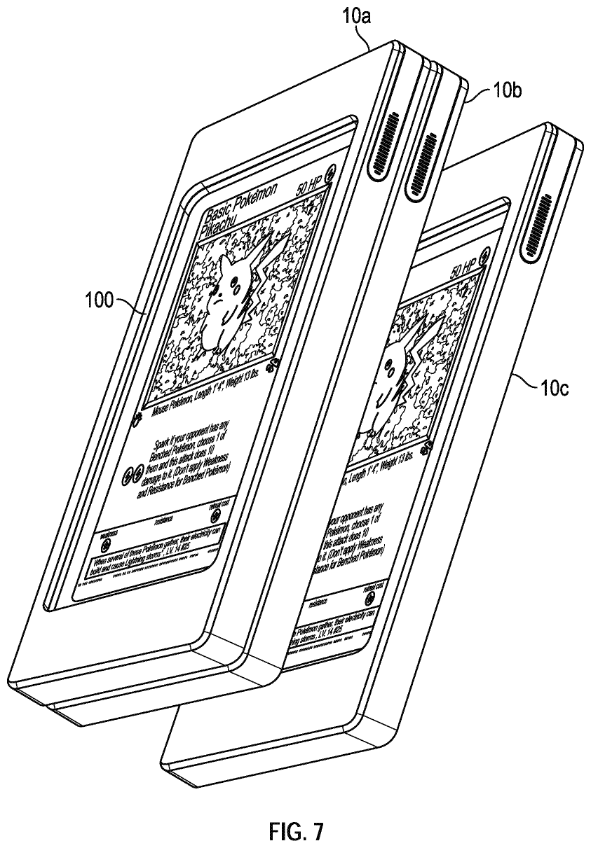

Referring now to FIGS. 1, 2 and 7, optionally an exterior major face of the bezel 12 can include a projection 98 and an opposing major face of the bezel 12 can include a recess 100. Referring now to the embodiment shown in FIG. 1, the rim 98 extends in a generally perpendicular direction and extends from the upper member 70 to the lower member 72. Referring now to FIG. 2, the recess 100 extends from the upper member 70 to the lower member 72 of the bezel 12. Referring now to FIG. 7, the rim 98 and the recess 100 have corresponding shapes, sizes, and configuration such to facilitate insertion one of the rims 98 of one case assembly 10a into the recess 100 of an adjacent case assembly 10b, thereby facilitating stacking of multiple case assemblies 10a, 10b and 10c in an interconnected manner.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions, and methods can be made within the scope of the present technology, with substantially similar results.

What is claimed is:

1. A protective case assembly configured to encase, protect, and present for viewing an object having a generally planar structure, the protective case assembly comprising:
a front case assembly having a transparent panel;
a rear case assembly configured for attachment to the front case assembly, the rear case assembly having a transparent panel, the rear case assembly configured to receive an object, in an attached orientation with the front case assembly, the object is viewable through the transparent panel of the rear case assembly and through the transparent panel of the front case assembly;
a bezel forming a cavity therewithin, the cavity configured to receive the front and rear case assemblies in an attached orientation in a manner such that the object is visible through a plurality of apertures formed in the bezel.

2. The protective case assembly of claim 1, wherein the front case assembly includes an upper fastener located at a first end of a perimeter framing.

3. The protective case assembly of claim 2, wherein the front case assembly includes a lower fastener located at a second end of the perimeter framing.

4. The protective case assembly of claim 3, wherein the upper and lower fasteners have the form of rare earth magnets.

5. The protective case assembly of claim 1, wherein the front case assembly includes a projecting tab that extends from a first end of a perimeter framing.

6. The protective case assembly of claim 1, wherein the transparent panel of the first case assembly is formed from Optium Museum Acrylic®.

7. The protective case assembly of claim 1, wherein the rear case assembly includes an upper fastener located at a first end of a perimeter framing.

8. The protective case assembly of claim 7, wherein the rear case assembly includes a lower fastener located at a second end of the perimeter framing.

9. The protective case assembly of claim 8, wherein the upper and lower fasteners have the form of rare earth magnets.

10. The protective case assembly of claim 1, wherein the rear case assembly includes an indentation configured to receive a projecting tab of the front perimeter framing.

11. The protective case assembly of claim 1, wherein a first end of a perimeter framing of the rear case assembly includes a thickened edge.

12. The protective case assembly of claim 11, wherein the cavity formed in the bezel extends through the thickened edge of the rear case assembly.

13. The protective case assembly of claim 11, wherein the thickened edge includes opposing grip portions.

14. The protective case assembly of claim 13, wherein each of the opposing grip portions includes one or more surface treatments.

15. The protective case assembly of claim 14, wherein the one or more surface treatments has the form of a plurality of raised lines.

16. The protective case assembly of claim 1, wherein the transparent panel of the second case assembly is formed from Optium Museum Acrylic®.

17. The protective case assembly of claim 1, wherein the rear case assembly includes a plurality of end fasteners located proximate a second end of a perimeter framing.

18. The protective case assembly of claim 17, wherein the bezel includes a plurality of interior fasteners positioned within the bottom member.

19. The protective case assembly of claim 18, wherein each of the plurality of end fasteners and each of the plurality of interior fasteners have the form of rare earth magnets.

20. The protective case assembly of claim 19, wherein in the installed arrangement, the plurality of interior fasteners of the bezel connect with the plurality of end fasteners of the rear case assembly.
